(19) United States
(12) Patent Application Publication
(10) Pub. No.: US 2013/0342891 A1
(43) Pub. Date: Dec. 26, 2013

(54) ELECTROWETTING DISPLAY DEVICE

(71) Applicant: WINTEK CORPORATION, Taichung City (TW)

(72) Inventors: Chih-Yuan Wang, Taichung City (TW); Cheng-Yi Chen, Changhua County (TW); Cheng-Yi Chou, Yunlin County (TW); Tai-Yen Lai, Taichung City (TW); Yu-Hua Wu, Taoyuan County (TW); Chen-Wei Li, Changhua County (TW)

(21) Appl. No.: 13/927,124

(22) Filed: Jun. 26, 2013

(30) Foreign Application Priority Data
Jun. 26, 2012 (TW) 101122781

(51) Int. Cl. G02B 26/00

(52) U.S. Cl. CPC G02B 26/005
USPC 359/290

(57) ABSTRACT

An electrowetting display device includes a lower substrate, an upper substrate, a medium layer, a lower electrode, an upper electrode, and a molecular chain layer. The medium layer is disposed between the lower substrate and the upper substrate. The medium layer includes a first medium and a second medium separated from each other. The first medium is a light transmission medium, and the second medium is a light-shielding medium. The lower electrode is disposed between the medium layer and the lower substrate. The molecular chain layer is disposed between the medium layer and the lower electrode. The molecular chain layer includes molecular chains. Each molecular chain has a first section and a second section. The first section is used to attract the first medium or repel the second medium. The second section is used to attract the second medium or repel the first medium.

### BACKGROUND OF THE INVENTION

1. Field of the Invention

The present invention generally relates to an electrowetting display device, and more particularly, to an electrowetting display device wherein changing the arrangement of molecular chains produces effects like repelling water and attracting oil or repelling oil and attracting water.

2. Description of the Prior Art

FIGS. 1 and 2 are schematic diagrams showing a conventional electrowetting display device. Please refer to FIGS. 1 and 2. As shown in FIGS. 1 and 2, the conventional electrowetting display device 100 includes a lower substrate 110 and an upper substrate 120 disposed opposite to each other. Components such as a lower electrode 130, an upper electrode 140, an insulating layer 150, a sealant 160, a polar aqueous solution 171 and an ink 172 are disposed between the lower substrate 110 and the upper substrate 120. The lower substrate 110, the upper substrate 120 and the sealant 160 are used to define a display region P. When there is no voltage applied between the lower electrode 130 and the upper electrode 140, the hydrophobic insulating layer 150 can distribute the ink 172 on a lower portion of the display region P (as shown in FIG. 1). When a voltage is applied between the lower electrode 130 and the upper electrode 140, induced charges may accumulate on the surface of the insulating layer 150 where the ink 172 is in contact. In this way, the surface tension of the ink 172 is changed and the distribution location of the ink 172 may therefore be well-controlled. By controlling the distribution location of the ink 172 within the display region P, light transmitting through the lower substrate 110 along a vertical projection direction Z may be affected and the display region P may therefore produce required display effects.

In conventional electrowetting display devices, an insulating layer generally includes silicon oxide, silicon nitride or the like, and a fluorination treatment of the surface of this insulating have to be carried out in order to enhance its hydrophobicity. This process, however, increases the manufacturing costs of the electrowetting display devices. Additionally, since conventional electrowetting display devices use induced surface charges to produce effects like attracting water and repelling oil, the distribution location of the ink is easily influenced by the surface height variation and the uniformity of the insulating layer, which therefore causes many problems to the ink flow, such as stagnant, slow or incomplete flow of ink.

### SUMMARY OF THE INVENTION

One object of the present invention is to provide an electrowetting display device, which controls the arrangement of molecular chains to achieve required effects like repelling water and attracting oil or repelling oil and attracting water so that the negative influence of the surface condition of an insulating layer may be prevented, and wherein a fluorination treatment of the surface of an insulating layer can be omitted, thereby reducing the manufacturing costs of the device.

According to one preferred embodiment of the present invention, an electrowetting display device is provided, which includes a lower substrate, an upper substrate, a medium layer, a lower electrode, an upper electrode and a molecular chain layer. The upper substrate and the lower substrate are disposed opposite to each other. The medium layer is disposed between the lower substrate and the upper substrate. The medium layer includes a first medium and a second medium separated from each other. The first medium is a light transmission medium, and the second medium is a light-shielding medium. The lower electrode is disposed between the medium layer and the lower substrate. The molecular chain layer is disposed between the medium layer and the lower electrode. The molecular chain layer includes molecular chains. Each molecular chain has a first section and a second section. The first section is used to attract the first medium or repel the second medium. The second section is used to attract the second medium or repel the first medium.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are schematic diagrams showing a conventional electrowetting display device.

FIGS. 3 and 4 are schematic diagrams showing an electrowetting display device according to a preferred embodiment of the present invention.

FIGS. 5 and 6 are schematic diagrams showing a condition of the operation of an electrowetting display device according to a preferred embodiment of the present invention.

FIGS. 7 and 8 are schematic diagrams showing a condition of the operation of an electrowetting display device according to another preferred embodiment of the present invention.

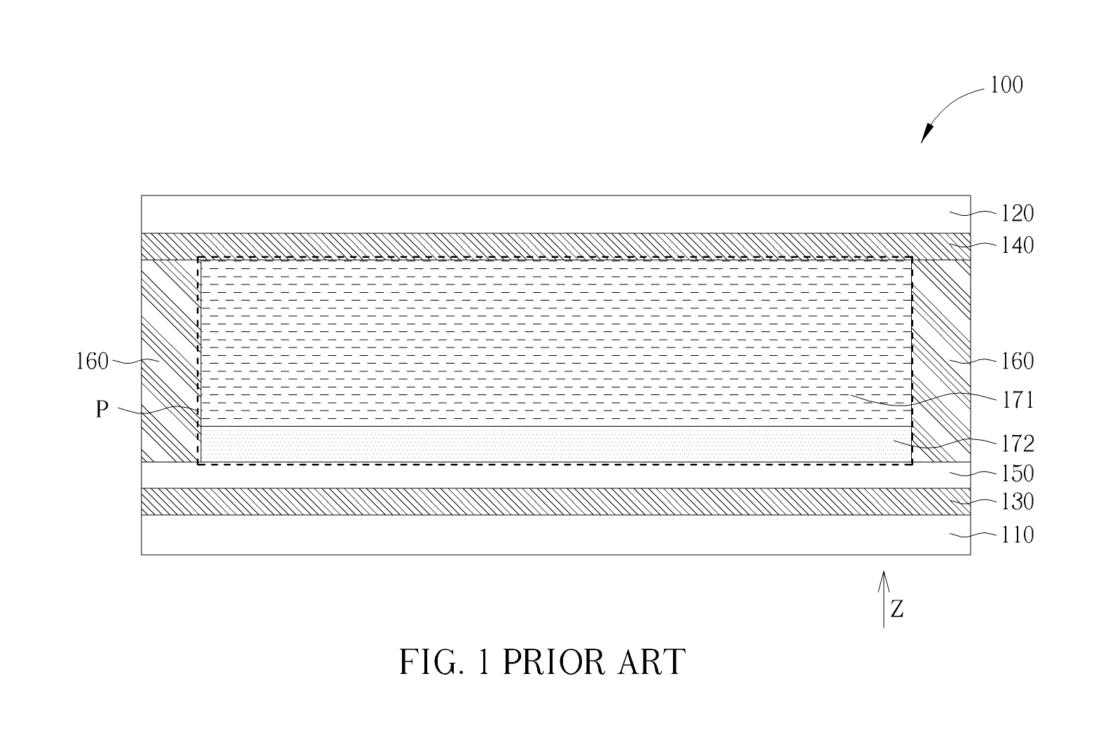

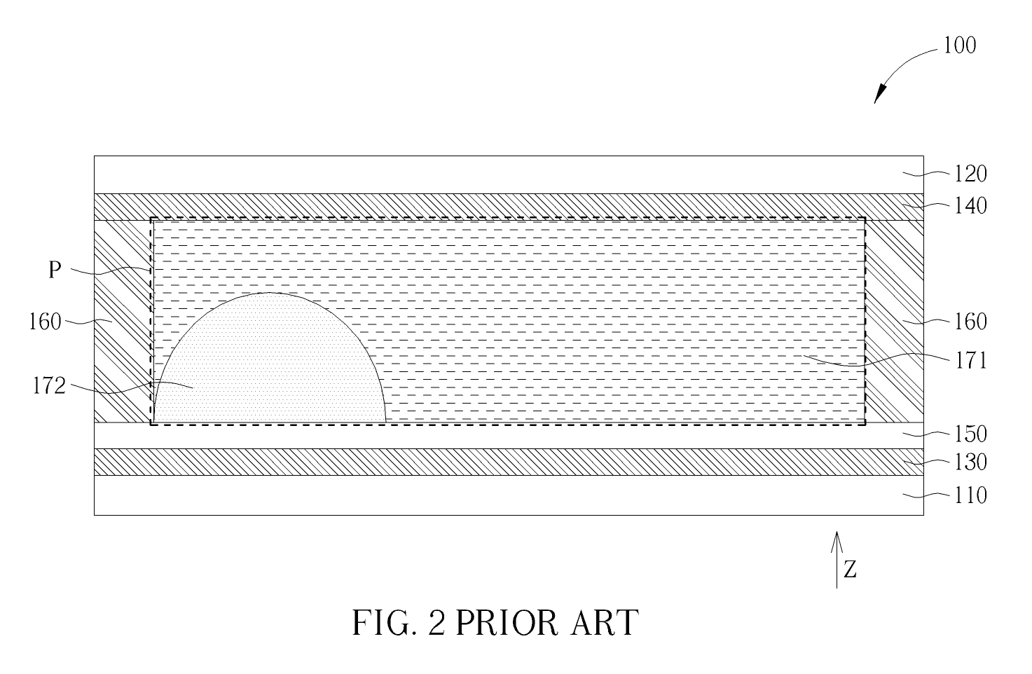

### DETAILED DESCRIPTION

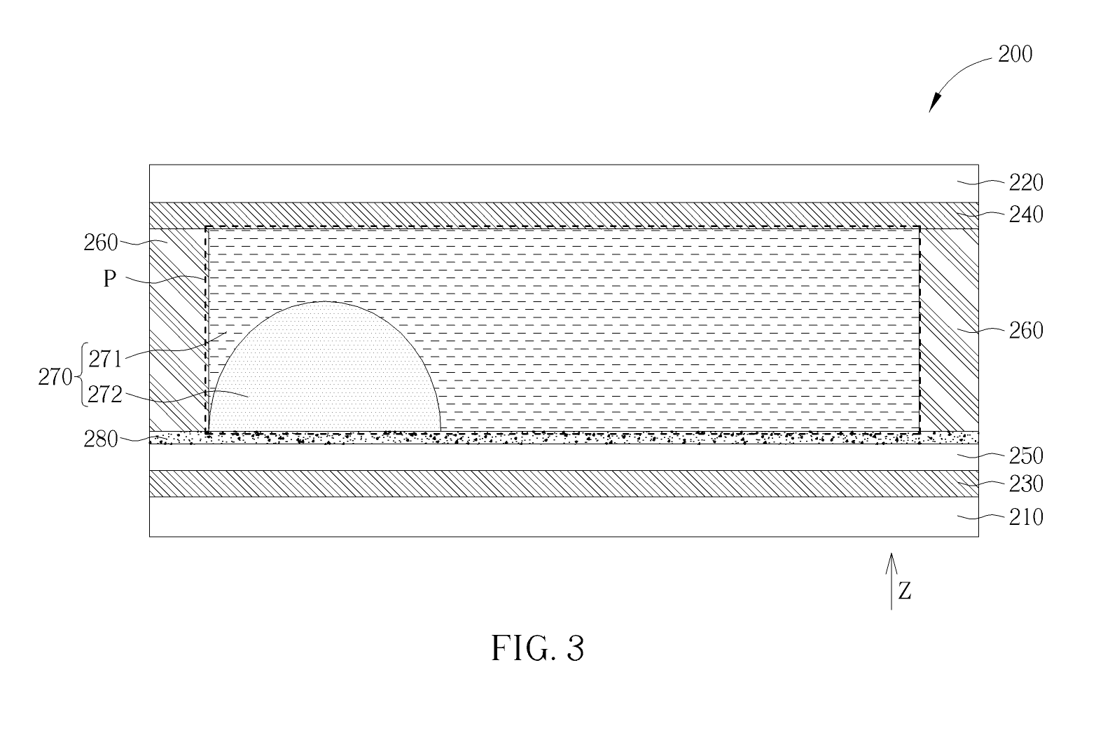

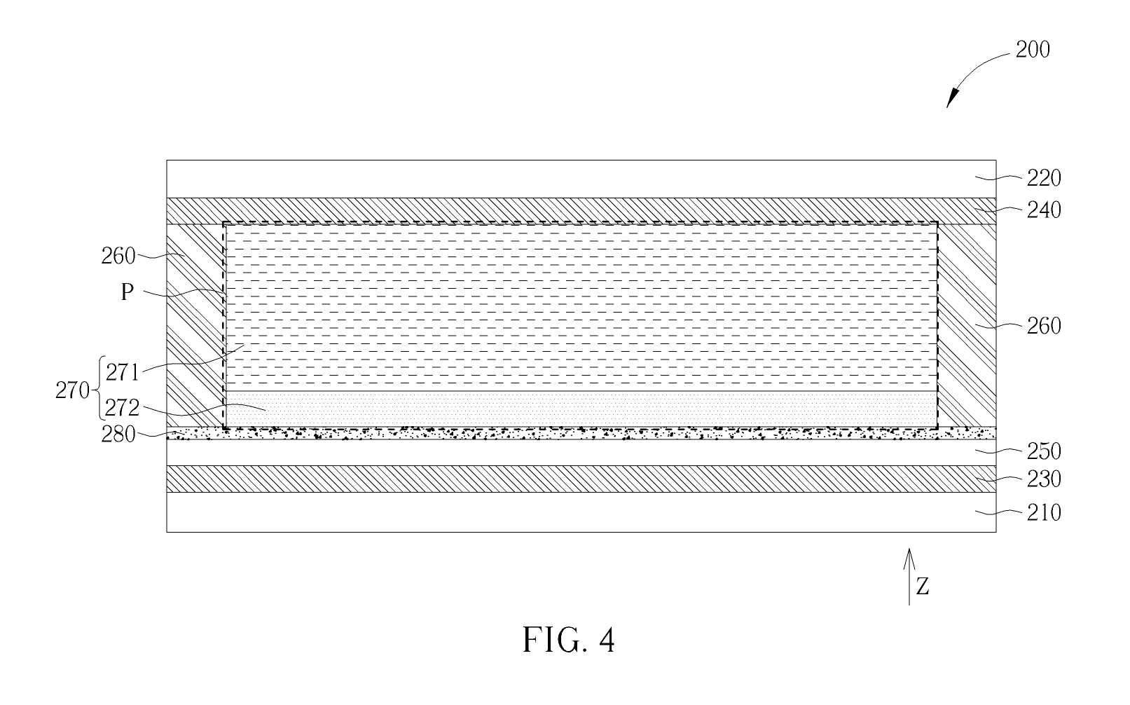

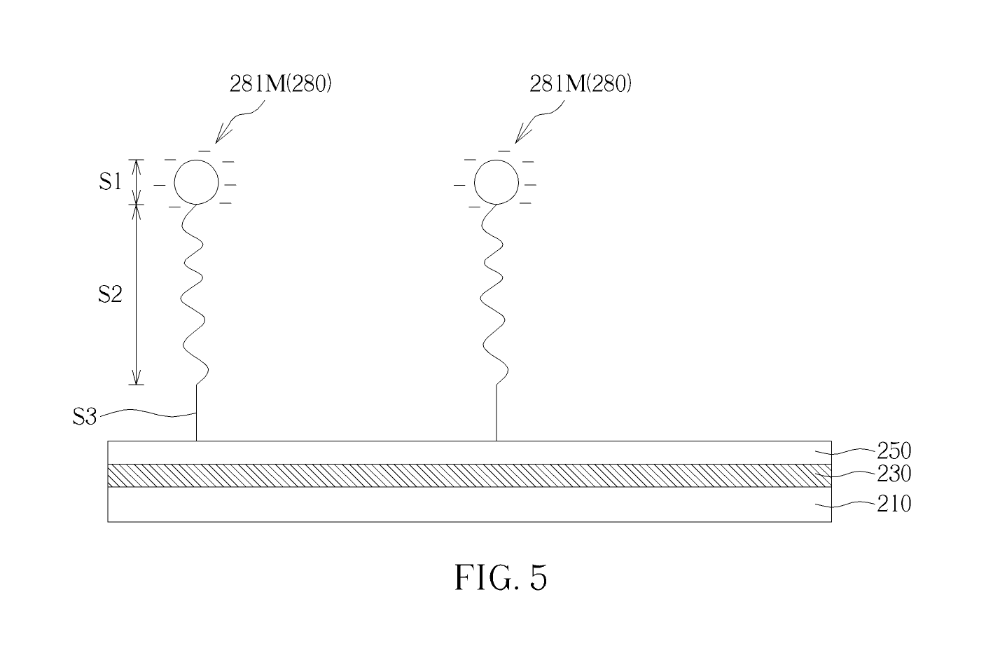

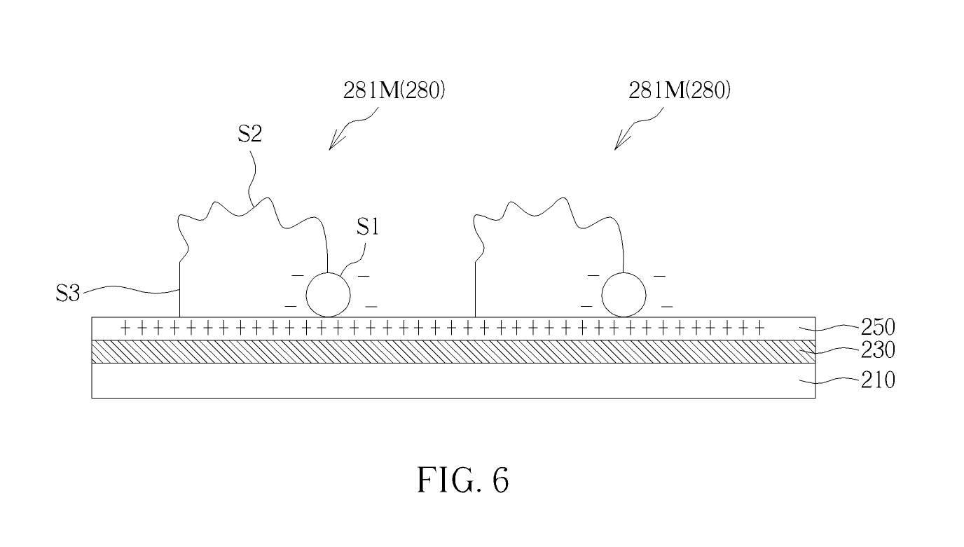

Please refer to FIGS. 3 to 6. FIGS. 3 and 4 are schematic diagrams showing an electrowetting display device according to a preferred embodiment of the present invention. FIGS. 5 and 6 are schematic diagrams showing a condition of the operation of an electrowetting display device according to a preferred embodiment of the present invention. It should be noted that the FIG. 5 is corresponding to FIG. 3, and the FIG. 6 is corresponding to FIG. 4. Additionally, all the figures are diagrammatic. Relative dimensions and proportions of parts of the drawings have been shown exaggerated or reduced in size, for the sake of clarity and convenience. That is to say, proportions of parts in the drawings may be modified according to actual design requirements. As shown in FIGS. 3 and 5, the present embodiment provides an electrowetting display device 200. The electrowetting display device 200 includes a lower substrate 210, an upper substrate 220, a lower electrode 230, an upper electrode 240, an insulating layer 250, a sealant 260, a medium layer 270 and a molecular chain layer 280. The upper substrate 210 is disposed opposite to the lower substrate 220. The upper substrate 210 and the lower substrate 220 may preferably include rigid substrates, such as glass substrates or ceramic substrates, or flexible substrates, such as plastic substrates or other substrates comprising suitable material. Additionally, the upper substrate 210 and the lower substrate 220 are preferably transparent substrates, but are not limited thereto. The medium layer 270 is disposed between the upper substrate 220 and the lower substrate 210. The lower electrode 230 is disposed between the lower substrate 210 and the medium layer 270, and the upper electrode 240 is disposed between the upper substrate 220 and the medium layer 270. The lower electrode 230 and the upper electrode 240 may preferably respectively be transparent electrodes, but not limited thereto. The medium layer 270 comprises a first medium 271 and a second medium 272 separated from each other, the first medium 271 is a light transmission medium and the second medium 272 is a light-shielding medium. A required display effect can be achieved through controlling the distribution of the first medium 271 and the second medium 272. According to this embodiment, the first medium 271 may preferably include a polar liquid material, and the second medium 272 may preferably include a non-polar liquid material, but not limit thereto. For example, the gas-phase first medium 271 is used together with the liquid-phase second medium 272 if required, according to other embodiments of the present invention.

In this embodiment, the sealant 260 is used to have the lower substrate 210 adhere to the upper substrate 220 and to define a display region P. The molecular chain layer 280 is disposed between the lower electrode 230 and the medium layer 270, and the insulating layer 250 is disposed between the molecular chain layer 280 and the lower electrode 230. The composition of the insulating layer 250 may preferably include silicon oxide, silicon nitride or other suitable material. The molecular chain layer 280 may include a plurality of molecular chains 281M, wherein each of the molecular chains 281M has a first section S1 and a second section S2. The first section S1 is used to attract the first medium 271 or repel the second medium 272, and the second section S2 is used to attract the second medium 272 or repel the first medium 271. As described in the previous paragraph, according to this embodiment, the first medium 271 may preferably include a polar liquid material, such as a polar aqueous solution, and the second medium 272 may preferably include a non-polar liquid material, such as ink, but not limit thereto. Correspondingly, the first section S1 of each molecular chain 281 may preferably include a hydrophilic functional group, and the second section S2 of each molecular chain 281 may preferably include a hydrophobic functional group, which may be used to respectively attract the first medium 271 and the second medium 272. The above-mentioned hydrophobic functional groups may include aliphatic groups, aromatic groups, silane, siloxane functional groups, halogenated long chains, composites of branched structure or high molecular chain structures. In addition, the first section S1 of each molecular chain 281M according to this embodiment may preferably include a hydrophilic group with negative charges, such as —S, —SO₃⁻, —SO₄⁻, −PO₃⁻, 13 PO₄⁻, —CN, —Al(OH)ₓ, —Fe(OH), —(OCH₂CH)ₓ⁻, —COO⁻, halogenated group, polyalcohol, poly acid, complex, metal complex and so forth, but is not limited thereto. The first section S1 of each molecular chain 281M according to the present invention may also be a functional group without any charges or with positive charges. It should be noted that the first section S1 of each molecular chain 281M is located at one end of each molecular chain 281M, and each molecular chain 281M further includes a link section S3 located at another end of each molecular chain 281M, and each second section S2 is located between each first section S1 and each link section S3. The link section S3 of each molecular chain 281M may preferably include boron, carbon, sulfur, silicon, phosphorous, nitrogen, oxygen or other suitable elements so that each molecular chain 281M may be attached to the insulating layer 250 and arranged along a same direction.

As shown in FIGS. 3 and 5, when no voltage is applied between the lower electrode 230 and the upper electrode 240, the first section S1 of each molecular chain 281M is exposed so that the first medium 271 can be attracted and the second medium 272 can be repelled by the molecular chain layer 280. In this condition, the second mediums 272 are repelled and accumulate at one corner of the display region P. As a result, the transmitted light along a vertical projection direction Z may be less influenced by the second mediums 272. In other words, when the medium layer 270 and the molecular chain layer 280 are not driven by the upper electrode 240 and the lower electrode 230, the molecular chain layer 280 repels the second medium 272 and attracts the first medium 271. In comparison, as shown in FIGS. 4 and 6, when a voltage is applied between the lower electrode 230 and the upper electrode 240, positive charges may accumulate in the insulating layer 250, and negative charges in the first region S1 of each molecular chain 281M will be attracted. Since the link section S3 of each molecular chain 281M is linked with the insulating layer 250, when the first section S1 is attracted by the insulating layer 250, the second section S2 can be therefore exposed and the molecular chain layer 280 may be converted to attract the second medium 272 and repel the first medium 271. In this condition, the entire second medium 272 is attracted and distributed on a lower portion of the display region P so that the transmitted light along the vertical projection direction Z may be affected by the second medium 272. In other words, when the medium layer 270 and the molecular chain layer 280 are driven by the upper electrode 240 and the lower electrode 230, the molecular chain layer 280 repels the first medium 271 and attracts the second medium 272. It should be also noted that, according to this embodiment, the electrowetting display device 200 may include a control device (not shown) if required, such as thin film transistors (TFT), in order to control the lower electrode 230 or the upper electrode 240 in an active drive way. The present invention, however, is not limited to this condition and the medium layer 280 may also be driven in a passive way.

The second medium 272 disclosed in this embodiment may preferably include a light-shielding liquid or a liquid with a certain color, and the first medium 272 is preferably a light transmission medium, but is not limited thereto. By properly controlling the arrangement of each molecular chain 281M together with adopting the suitable second medium 272, the second medium 272 can be attracted or repelled through the above-mentioned processes and the electrowetting display device 200 can therefore achieve a required display effect. It is worth noting that, according to this embodiment of the present invention, since each molecular chain 281M disposed in the electrowetting display device 200 has sections for respectively attracting the first medium 271 and attracting the second medium 272, and the second medium 272 can be attracted or repelled by properly controlling the arrangement of each molecular chain 281M, the flow of the second medium 272 may be therefore relatively not influenced by the surface condition of the insulating layer 250. As a result, the response rate can be improved. Additionally, since the surface of the insulating layer 250 don't need to have hydrophobic properties under a condition without driving voltage, a fluorination treatment of the surface of the insulating layer 250 can be omitted and the manufacturing costs of the device are therefore reduced. It should be also noted that, according to other preferred embodiments of the present invention, the second section S2 of each molecular chain 281M may be located at one end of each molecular chain 281M, and the first section S1 may be located between each second section S2 and link section S3 if required. Under this condition, when each molecular chain 281M is driven by a certain voltage, the first medium 271 may be attracted or the second medium 272 may be repelled as a consequence. In other words, when the first medium 271 is a polar aqueous solution and the second medium 272 is a non-polar ink, required effects, such as repelling water and attracting oil or repelling oil and attracting water, may be achieved by properly controlling the arrangement of each molecular chain 281M. Through these effects (repelling water and attracting oil or repelling oil and attracting water), the distribution location of the second medium 272 in the display region P may be well-controlled and the electrowetting display device can therefore achieve required display effects.

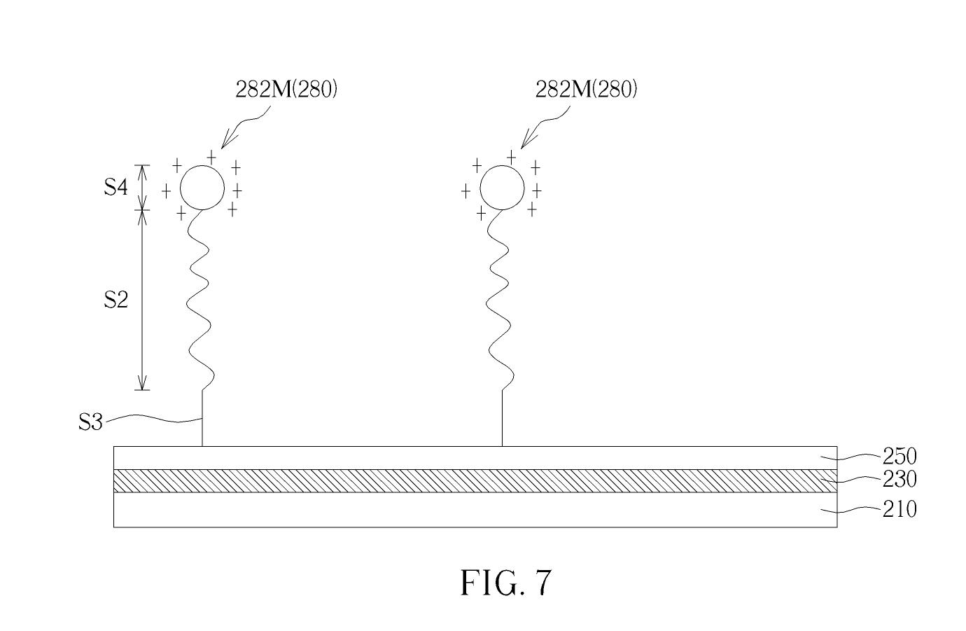

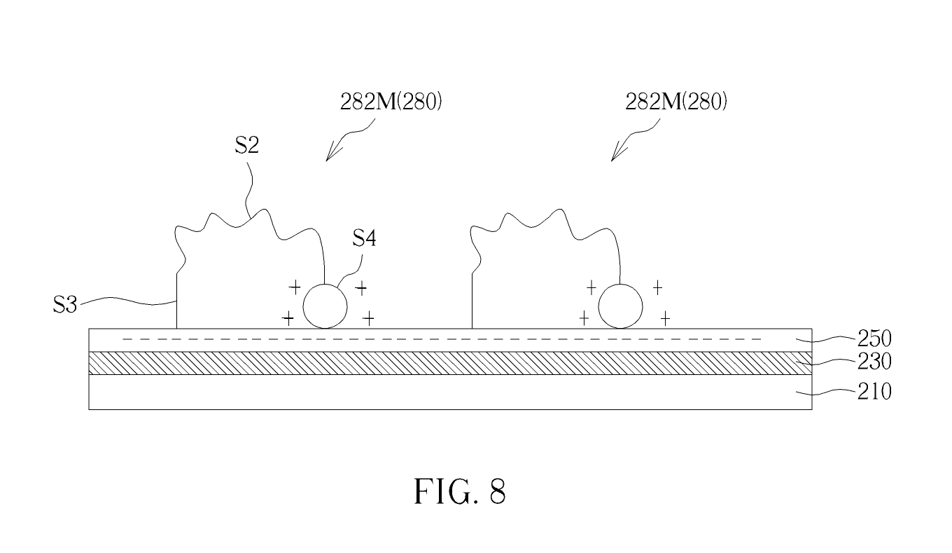

Please refer to FIGS. 7 and 8 together with FIGS. 4 and 5. FIGS. 7 and 8 are schematic diagrams showing a condition of the operation of an electrowetting display device according to another preferred embodiment of the present invention. The FIG. 7 is corresponding to FIG. 3, and the FIG. 8 is corresponding to FIG. 4. According to this embodiment, a molecular chain layer 280 includes a plurality of molecular chains 282M, each of the molecular chains 282M has a first section S4, a second section S2 and a link section S3. Unlike in the above preferred embodiments, the first section S4 of each molecular chain 282M disclosed in this embodiment may preferably include a hydrophilic functional group with positive charges, such as nitrogen-containing functional groups, primary amine, secondary amine, tertiary amine, ammonium salts, azo groups, azide groups or the like, but not limited thereto. Additionally, the first section S4 of each molecular chain 282M is located at one end of each molecular chain 282M, and the link section S3 of each molecular chain 282M preferably located at another end of each molecular chain 282M, and each second section S2 is located between each first section S4 and each link section S3. Accordingly, as shown in FIGS. 4 and 8, when a voltage is applied between the lower electrode 230 and the upper electrode 240, negative charges may accumulate in the insulating layer 250 and positive charges in the first region S4 of each molecular chain 281M may be attracted. Since the link section S3 of each molecular chain 282M is linked to the insulating layer 250, when the first section S4 is attracted by the insulating layer 250, the second section S2 can be therefore exposed. As a result, the molecular chain layer 280 is able to attract the second medium 272 and repel the first medium 271. Apart from the charges generating under a condition of driving the medium layer 270 and the molecular chain layer 280, the rest of the parts disclosed in this embodiment, as well as the characteristics of other parts, material properties and the way of driving are almost similar to those described in the previous preferred embodiment. For the sake of brevity, these similar configurations and properties are therefore not disclosed in detail.

To summarize, according to the present invention, since each molecular chain disposed in the electrowetting display device has sections for respectively attracting the first medium and attracting the second medium, the second medium can be attracted or repelled through properly controlling the arrangement of each molecular chain. As a result, the distribution of the second medium may be well-controlled and the electrowetting display device can therefore achieve a required display effect. Additionally, since the arrangement of the molecular chains can be controlled to have the molecular chains provide required effects like repelling water and attracting oil or repelling oil and attracting water, the flow of the second medium may be therefore relatively not influenced by the surface condition of the insulating layer. As a result, the response rate can be improved. Additionally, since the surface of the insulating layer don't need to have hydrophobic properties under the condition without driving voltage, a fluorination treatment of the surface of the insulating layer can be omitted and the manufacturing costs of the device are therefore reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrowetting display device, comprising:
a lower substrate;
an upper substrate disposed opposite to the lower substrate;
a medium layer disposed between the upper substrate and the lower substrate, wherein the medium layer comprises a first medium and a second medium separated from each other, wherein the first medium is a light transmission medium and the second medium is a light-shielding medium;
a lower electrode disposed between the lower substrate and the medium layer;
an upper electrode disposed between the upper substrate and the medium layer; and
a molecular chain layer disposed between the lower electrode and the medium layer, wherein the molecular chain layer comprises a plurality of molecular chains, and each of the molecular chains has a first section and a second section, such that the first section is used to attract the first medium or repel the second medium, and the second section is used to attract the second medium or repel the first medium.

2. The electrowetting display device according to claim 1, wherein the first medium comprises a polar liquid material, and the second medium comprises a non-polar liquid material.

3. The electrowetting display device according to claim 2, wherein the first section of each of the molecular chains comprises a hydrophilic functional group, and the second section of each of the molecular chains comprises a hydrophobic functional group.

4. The electrowetting display device according to claim 3, wherein the first section of each of the molecular chains comprises a hydrophilic functional group with positive charges.

5. The electrowetting display device according to claim 3, wherein the first section of each of the molecular chains comprises a hydrophilic functional group with negative charges.

6. The electrowetting display device according to claim 1, further comprising an insulating layer disposed between the molecular chain layer and the lower electrode.

7. The electrowetting display device according to claim 1, wherein when the medium layer and the molecular chain layer are not driven by the upper electrode and the lower electrode, the molecular chain layer repels the second medium or attracts the first medium.

8. The electrowetting display device according to claim 1, wherein when the medium layer and the molecular chain layer are driven by the upper electrode and the lower electrode, the molecular chain layer repels the first medium or attracts the second medium.

9. The electrowetting display device according to claim 6, wherein the first section of each of the molecular chains is located at one end of each of the molecular chains, and each of the molecular chains further comprises a link section at another end of the each of the molecular chains, each of the second sections is located between each of the first sections and each of the link sections, and the link sections are used to attach the molecular chains to the insulating layer.

10. The electrowetting display device according to claim 9, wherein the link section of each of the molecular chains comprises boron, carbon, sulfur, silicon, phosphorous, nitrogen or oxygen.
